(19) United States
(12) Patent Application Publication
(10) Pub. No.: US 2012/0049430 A1
(43) Pub. Date: Mar. 1, 2012

(54) Controller for supporting workpieces on an operating machine

(76) Inventors: Pietro Aceti, Bergamo (IT); Stefano Aceti, Bergamo (IT)

(21) Appl. No.: 12/898,019

(22) Filed: Oct. 5, 2010

(30) Foreign Application Priority Data
Aug. 25, 2010 (IT) BS2010A000145

(51) Int. Cl. B25B 11/00

(52) U.S. Cl. 269/21

(57) ABSTRACT

A controller is provided for machining devices of the type having a workpiece support table with a plurality of vacuum support devices mounted thereon for heightwise movement between an active raised position and an inactive lowered position. The controller includes at least one hydropneumatic actuator operably connected with the vacuum support devices, and shifting the same between the raised and lowered positions. A synchronization bar has at least one lock member that selectively engages and displaces heightwise in unison and at the same time each of the vacuum support devices operated by the hydropneumatic actuator.

### CLAIM TO PRIORITY

Applicants hereby claim the priority benefits under the provisions of 35 U.S.C. §119, basing said claim of priority on Italian Patent Application BS2010A000145, filed Aug. 25, 2010.

### BACKGROUND OF THE INVENTION

1. Field of the Invention

The present invention relates to forming machines, and in particular to machines for profiling, shaping, cutting, sectioning, etc., various materials in sheet form, such as marble, granite and the like. The invention pertains more specifically to a controller and related system for positioning supporting devices that retain a sheet, or a flat workpiece, on the work table of an associated operating machine.

2. Prior Art

In the pertinent field of art, machining operations to be carried out on workpieces made of various materials, such as sheets of marble, granite and the like, may be performed using an operating or forming machine having a table for supporting the initial workpiece, a bridge structure situated above the workpiece support table and at least one operating head or electric chuck with at least one tool mounted on the bridge structure and movable relative to the workpiece on said table.

The workpiece to be machined may be arranged and retained directly on the workpiece support table, but most frequently, must be kept in a raised position above the table when it is cut, sectioned and/or machined peripherally. For this second arrangement, it is customary to use support devices which are mounted on the workpiece support table and used depending on the geometry and dimensions of the workpiece and/or the machining operations to be carried out on it, and which must therefore be repositioned whenever the shape of the workpiece to be machined varies.

These support devices may be in the form of vacuum support devices or suckers, small tables or the like. For the sake of simplicity, but without this constituting a limitation to the scope of the invention, in the present description, reference will be made solely to support devices in the form of suckers.

The workpiece support table may be provided with a grid of suction holes which can be connected selectively to a vacuum-generating apparatus, wherein the suckers are arranged on said table opposite the holes according to the specific needs of the particular application, so as to define the actual work surface for the workpiece. Alternatively, the suckers are arranged on the workpiece support table, and may themselves be connected individually to a vacuum-generating apparatus directly.

In order to position the workpiece on the workpiece support table, and allow the required machining operations to be carried out repeatedly on various parts of the workpiece to be machined, the suckers are movable, i.e., each movable selectively between an active raised position where the workpiece is supported thereon, and an inactive, concealed, lowered position, so as to avoid interference with the machining operations to be performed, wherein said positions may be defined by fixed stops.

Such support suckers, which are movable and also directable, are generally known in the art. However, such support suckers, even though they may be arranged in the most suitable positions for the shape and size of the workpiece to be machined, when controlled according to the present state of the art technology, do not typically ensure a precise flatness and horizontal arrangement of the workpiece, so that the machining of every part thereof may be correctly and repeatedly performed. These suckers, in fact, may be operated only individually, with the problem being that it is not possible to ensure that all activated suckers will in each case assume the same height above the table, so that there may not be a properly flat support surface, thereby negatively affecting the stability and horizontal arrangement of the workpiece supported.

### SUMMARY OF THE INVENTION

One object of the present invention is to solve effectively the above-mentioned problems, and provide a mechanism for accurate operation and synchronized heightwise movement of the support suckers activated in each case.

This object, and the implicit advantages arising therefrom, are achieved by a machine controller and related operating system according to at least claim 1, comprising a hydropneumatic actuator module for each sucker to be operated, and a synchronization bar that is able to engage with and displace heightwise, in unison and at the same time, all the suckers operated by the respective hydropneumatic actuators.

Advantageously, therefore, the support suckers may each be chosen individually and selectively by the respective hydropneumatic actuator. Then, the suckers to be actually activated are displaced heightwise with the aid of a mechanical synchronization bar, so as to be kept level during movement and be able to ensure that the workpiece resting thereon is flat and horizontal.

Moreover, the actuator modules for the suckers on the workpiece support table may be grouped together in an ordered manner in a set on a single stand, in combination with the mechanical synchronization device, and this set of modules may be arranged alongside the workpiece support table or also at a distance therefrom according to needs.

The whole arrangement will be managed by an operating program preset on the basis of the number and location of the suckers on the workpiece support table and the shape and size of the workpieces to be machined, which may involve the use of a variable number of suckers.

These and other advantages of the invention will be further understood and appreciated by those skilled in the art by reference to the following written specification, claims and appended drawings.

### BRIEF DESCRIPTION OF THE DRAWINGS

The invention will moreover be illustrated more clearly in the remainder of the present description provided with reference to the accompanying drawings, which are provided by way of a non-limiting example and in which:

FIG. 1 shows in schematic form a plan view of a machine tool with some support suckers on the workpiece support table;

FIG. 2 shows a diagram of a hydropneumatic actuator module for operating each individual support sucker;

FIG. 3 shows an example of a set of hydropneumatic units for operating a corresponding number of suckers, together with a mechanism for synchronizing the heightwise movements thereof;

FIG. 4 shows an example of a set of solenoid valves for managing the hydropneumatic cylinders and the synchronization mechanism shown in FIG. 3; and

FIG. 5 shows another example of a set of hydropneumatic units for operating a different number of suckers.

### DETAILED DESCRIPTION OF THE PREFERRED EMBODIMENTS

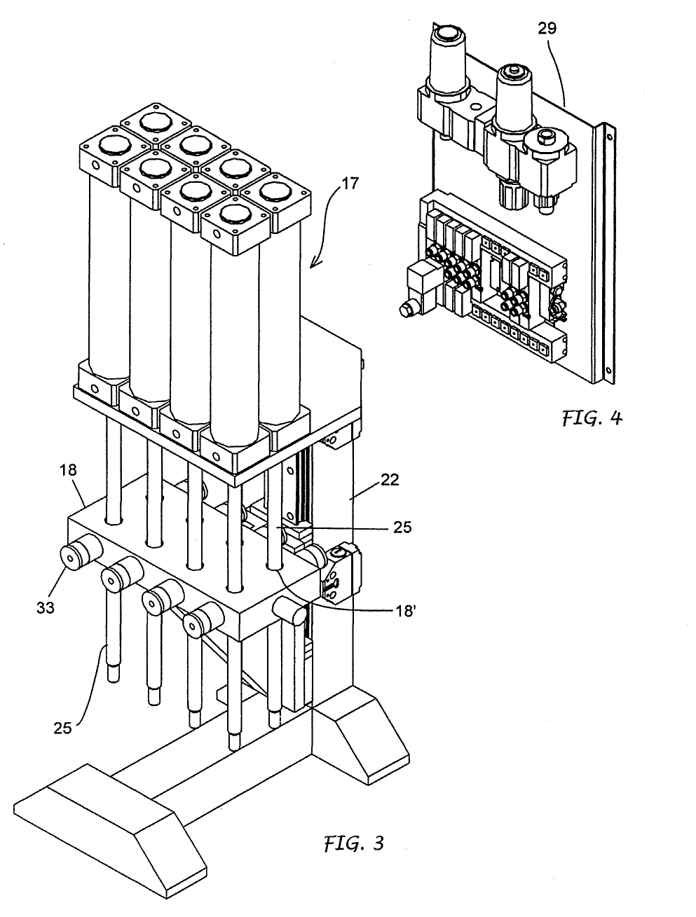

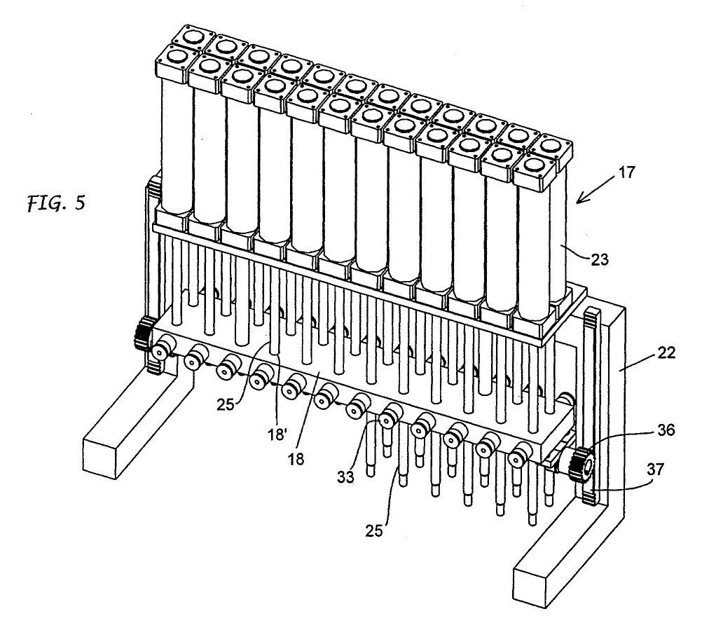

For purposes of description herein, the terms “upper”, “lower”, “right”, “left”, “rear”, “front”, “vertical”, “horizontal” and derivatives thereof shall relate to the invention as oriented in FIGS. 3 and 5. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

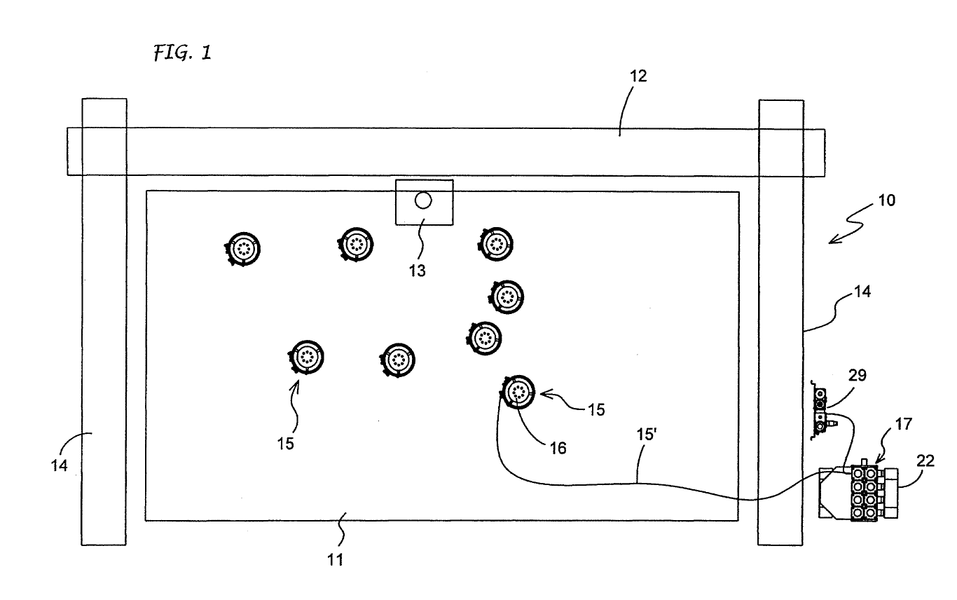

The drawings, in particular FIG. 1, show a machining apparatus or operating machine for machining materials, such as sheets of marble, granite or the like, denoted overall by 10, having a workpiece support table 11 with a bridge crosspiece or beam 12 disposed above workpiece support table 11, which carries at least one operating head 13 or electric chuck.

The workpiece support table 11 is equipped with a support mechanism 15 which is arranged and used to define a support surface for the workpiece to be machined in a raised position above the table itself. The bridge beam 12 is movable on two shoulders 14 horizontally above the workpiece support table 11 along a first axis, while the operating head 13 is movable on and relative to the bridge beam 12 and the workpiece support table along at least two axes which are at right angles to each other, and perpendicular to the axis of movement of the bridge beam.

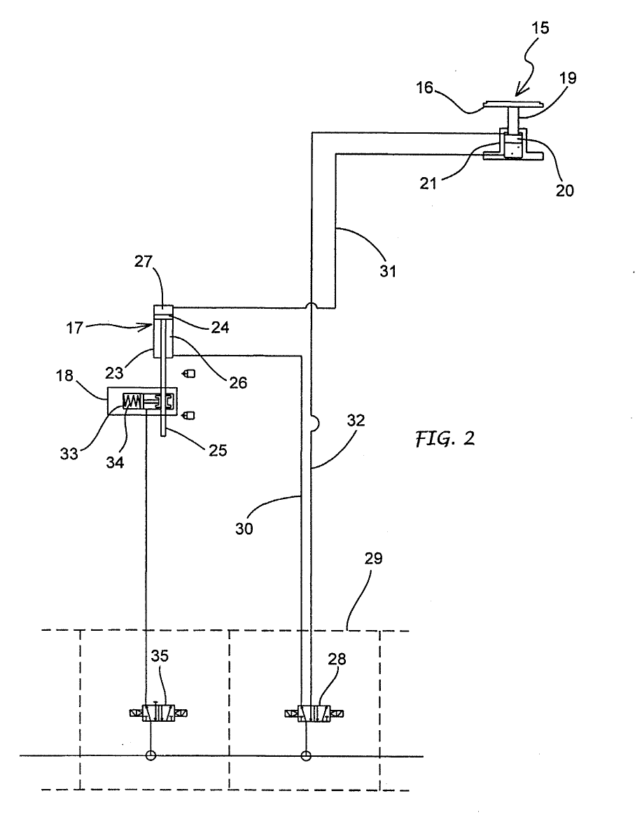

In the example shown in FIG. 2, the support mechanism 15 is in the form of vacuum support devices or suckers 16, which are located on the table 11 and can be selectively connected to the distributor portion of a vacuum-generating apparatus (not shown) by means of mobile pipes 15′. The number and arrangement of the support mechanism 15, i.e., the suckers 16, on the workpiece support table 11 may be chosen in each case depending on the shape and size of the workpiece and the machining operations to be performed on various parts of the workpiece.

The suckers 16 may be used selectively, activating them so as to displace them heightwise above the workpiece support table 11 between a raised active position and a lowered inactive position, and then selectively applying a vacuum to the same.

According to one feature of the invention, each sucker 16 is connected to a hydropneumatic actuator module 17, and all the suckers 16 are associated with a synchronization bar 18.

In particular, for its displacements heightwise, each sucker is constrained to and movable with the stem 19 of a vertical-axis piston 20 operating inside a first hydraulic cylinder 21 mounted on the workpiece support table 11.

The hydropneumatic actuator module 17 associated with each sucker 16 is arranged in a set, together with the actuators 17 of the other suckers 16, outside of the workpiece support table 11, on one side thereof, and underneath or at a distance therefrom. The hydropneumatic actuator modules 17 will therefore be at least of a number equal to the number of suckers 16 on the workpiece support table 11 shown in FIG. 1, and grouped together in a set on a common stand 22. Thus, for example, sets of eight actuator modules 17 may be provided, as shown in FIGS. 1 and 3, twenty four actuator modules 17, as shown in FIG. 5, or any other number depending on the number of suckers 16 available and/or to be used on the same workpiece support table 11.

In greater detail, moreover, each illustrated hydropneumatic actuator module 17 comprises a second cylinder 23, inside which a piston 24 is provided with a stem 25 that emerges or extends outwardly from one end of the cylinder 23. The piston 24 defines on two opposite sides thereof inside the cylinder 23 of the actuator module 17, a first chamber 26 intended to receive a gas or an aeriform fluid, typically pressurized air, and a second chamber 27 intended to receive a liquid fluid, such as a hydraulic oil.

The first chamber 26 of the cylinder 23 of the actuator module 17 is supplied with and discharges therefrom pressurized air via a solenoid control valve 28, which is located on a control panel 29, through a respective so-called “up” connection line 30. The second chamber 27 of the same cylinder 23 containing hydraulic fluid is in fluid communication, via a two-way connection pipe 31, with the hydraulic first cylinder 21, which operates the sucker 16, on one side of the respective piston 20. On the other side of the piston 20, the first cylinder 21, which operates the sucker 16, has an outlet port connected to the above-mentioned solenoid control valve 28 via a so-called “down” connection line 32.

The hydropneumatic actuator module 17 may be designed as per the diagram shown, for example, in FIG. 2. In the embodiment shown in FIG. 2, the delivery of air to the first chamber 26 of the second cylinder 23 of the actuator module 17 is via the line 30, and contemporaneously causes the discharging of air from the sucker support first cylinder 21 towards the solenoid valve 28, which in turn produces a corresponding flow of hydraulic fluid from the second cylinder 23 of said actuator module 17 to the first cylinder 21 supporting the sucker 16, so as to activate the latter, displacing it from a lowered position into a raised position.

Vice versa, the delivery of air, via the line 32, into the first cylinder 21 supporting the sucker 16, together with the discharging of air from the first chamber 26 of the second cylinder 23 of the actuator module 17 towards the solenoid valve 28, produces a corresponding return of the hydraulic fluid from the first cylinder 21 supporting the sucker 16 into the second chamber 27 of the second cylinder 23 of the actuator module 17, so as to deactivate the sucker 16 by displacement from the raised position to the lowered, concealed position.

According to another aspect of the present invention, synchronization of the movement of each of the suckers 16 to be activated for a particular application is performed mechanically by the synchronization bar 18. For this purpose, and as shown in the example illustrated in FIG. 3, the stem 25 of each second cylinder 23 of the actuator module 17 extends inside and through a hole 18′ formed in the synchronization bar 18, and is selectively locked to the bar 18 by a stem locking device 33. The stem locking device 33 is normally kept in an unlocked position by means of an associated cylinder supplied with a fluid, preferably compressed air, delivered via a solenoid control valve 35 (FIG. 2), so as to allow free sliding of the stem 25 with respect to the synchronization bar 18. The stem locking device 33 is kept in the locked operating position by means of at least one spring 34.

The synchronization bar 18 is guided on and displaceable or shiftable along the stand 22 retaining the set of actuator modules 17, in a direction generally parallel to itself, by means of a movement system preferably of the mechanical type, which comprises in the illustrated example, at least one toothed pinion 36, which is driven and is movable along a mating toothed rack 37, which extends generally parallel to the stems 25 of the set of actuator modules 17, or by some other rigid guide system.

Therefore, by means of the synchronization bar 18, it is possible to operate simultaneously and in parallel all the suckers 16 which must be raised and activated for a particular application in order to support a workpiece, leaving the other suckers 16 lowered and inoperative. In order to activate the suckers 16, it is sufficient to lock their stems 25 to the synchronization bar 18 by the respective stem locking device 33 and supply pressurized air to the first chambers 26 of the second cylinders 23 of the actuator modules 17, which are operably connected so as to cause the delivery of hydraulic fluid from the second chambers 27 of said second cylinders 23 to the first cylinders operating the suckers 16 to be raised. The synchronization bar 18 will allow precise raising of all the suckers 16 thus operated, by the same amount, so as to define a resting surface having a flat and horizontal support for the workpiece which rests thereon in order to perform machining thereof.

It should be noted moreover that the apparatus and system described above may be subject to variations or modifications without departing from the scope of the invention.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1-7. (canceled)

8. An apparatus for machining workpieces, comprising:
a workpiece support table having an upper portion thereof configured for operably supporting a workpiece thereon;
a plurality of vacuum support devices, each being mounted on said upper portion of said workpiece support table, having a portion thereof operably connected with a vacuum and being movable heightwise between an active raised position and an inactive lowered position;
at least one hydropneumatic actuator operably connected with at least one of said vacuum support devices and shifting the same between said active raised position and said inactive lowered position; and
a synchronization bar having at least one lock member which selectively engages and displaces heightwise in unison and at the same time each of said vacuum support devices operated by said hydropneumatic actuator.

9. An apparatus as set forth in claim 8, including:
a common stand located a preselected distance from said workpiece support table; and wherein
said at least one hydropneumatic actuator comprises a plurality of hydropneumatic actuators which are grouped together in a set and supported on said common stand; and
said synchronization bar is guided on and displaceable along said stand in a direction substantially parallel therewith.

10. An apparatus as set forth in claim 9, wherein:
each of said vacuum support devices includes a hydraulic first cylinder mounted on said workpiece support table and having a reciprocating stem which shifts said vacuum support device along a generally vertical axis between said active raised position and said inactive lowered position;
each said hydropneumatic actuator includes a second cylinder having a reciprocating piston which defines in said second cylinder a first chamber having pressurized aeriform fluid therein, and a second chamber having hydraulic fluid therein; and
a distribution solenoid valve operably connected with said first chamber of said second cylinder by an up connection line to selectively communicate pressurized aeriform fluid therewith.

11. An apparatus as set forth in claim 10, wherein:
said second chamber of said second cylinder is in fluid communication with said first cylinder; and
said first cylinder includes a piston reciprocating with said stem, and having on one side thereof an outlet port that is operably connected to said distribution solenoid valve, whereby delivery of aeriform fluid to said first chamber of said second cylinder and the contemporaneous discharge of aeriform fluid from said first cylinder toward said solenoid valve produce a corresponding flow of hydraulic fluid from said second chamber of said second cylinder to said first cylinder so as to shift said vacuum support device from said inactive lowered position to said active raised position, and whereby the delivery of aeriform fluid into said first cylinder and the contemporaneous discharge of aeriform fluid from said first chamber of said second cylinder toward said solenoid valve produce a corresponding return of the hydraulic fluid from said first cylinder into said second chamber of said second cylinder so as to shift said vacuum support device from said active raised position to said inactive lowered position.

12. An apparatus as set forth in claim 11, wherein:
said piston of said second cylinder includes a stem which extends through said second cylinder and has a free end thereof disposed external to said second cylinder;
said synchronization bar includes at least one aperture therein for individually receiving therein in a sliding manner said free end of said stem on said second cylinder; and wherein
said lock member comprises a stem locking device which selectively locks and unlocks said stem on said second cylinder with said synchronization bar.

13. An apparatus as set forth in claim 12, wherein:
said stem locking device includes an operating position wherein said stem and said synchronization bar are operably locked and shift together, and a non-operating position wherein said stem and said synchronization bar are operably unlocked and do not shift together.

14. An apparatus as set forth in claim 13, wherein:
said stem locking device includes a pneumatic cylinder for shifting said stem locking device to an unlocked position, and a spring for maintaining said stem locking device in a locked position.

15. A controller for machining devices of the type having a workpiece support table with an upper portion thereof configured for operably supporting a workpiece thereon and a plurality of vacuum support devices which are movable heightwise between an active raised position and an inactive lowered position, comprising:
at least one hydropneumatic actuator configured for operable connection with at least one of the vacuum support devices and shifting the same between the active raised position and the inactive lowered position; and
a synchronization bar having at least one lock member which selectively engages and displaces heightwise in unison and at the same time each of the vacuum support devices operated by said hydropneumatic actuator.
